(19) United States
(12) Patent Application Publication
(10) Pub. No.: US 2023/0267440 A1
(43) Pub. Date: Aug. 24, 2023

(54) PAPERLESS PROOF OF PURCHASE SOFTWARE SYSTEM

(71) Applicant: THRML Technologies Incorporated, Seattle, WA (US)

(72) Inventor: Christopher Nelson, Seattle, WA (US)

(21) Appl. No.: 18/112,085

(22) Filed: Feb. 21, 2023

Related U.S. Application Data
(60) Provisional application No. 63/312,312, filed on Feb. 21, 2022.

(51) Int. Cl. G06Q 20/20; G06Q 20/32

(52) U.S. Cl. CPC G06Q 20/209; G06Q 20/3278

(57) ABSTRACT

Systems and methods for automatically intercepting and repurposing a point-of-sale receipt print spool to eliminate a paper receipt and generating an electronic receipt integrated into a user's own financial accounting and banking systems without the need to provide a user's email at the point of sale or otherwise compromising the user's privacy or data.

### CROSS-REFERENCE TO RELATED APPLICATIONS

This application claims priority benefit of U.S. Provisional Application No. 63/312,312 filed Feb. 21, 2022, the entire contents of which are incorporated herein by reference.

### COPYRIGHT NOTICE

This disclosure is protected under United States and/or International Copyright Laws.© 2023 THRML Technologies, Inc. All Rights Reserved. A portion of the disclosure of this patent document contains material which is subject to copyright protection. The copyright owner has no objection to the facsimile reproduction by anyone of the patent document or the patent disclosure, as it appears in the Patent and/or Trademark Office patent file or records, but otherwise reserves all copyrights whatsoever.

### BACKGROUND

The THRML Merchant Software (TMS) is designed to eliminate the need for paper receipts. The software works in conjunction with a Near Field Communicator to identify the consumer and their account information, supply the proof of purchase to the THRML server component, and then erase the print command from the merchant print queue.

The most commonly provided substitute for paper receipts has been the email receipt option provided by merchant. However, the Thermal Merchant Software, in conjunction with the THRML Near Field Communication Reader, will not require consumers or patrons to physically enter their email at the time of time of transaction.

The email receipt option does not take into account a variety of factors. First: time consumption. As electronic payment has become the dominant process for consumer payment, transaction times have shortened greatly. The added length of entering or reciting an email address at a check stand has caused the process to fail in the adoption stage. Second: organization. The average American has 3.5 email addresses. Therefore, the email provided for emailed receipts varies. Consumers may find themselves browsing multiple inboxes for a proof of purchase. Additionally, emails are stored among other key pieces of information inside of an inbox, causing confusion and disincentiving proper organization. Third: privacy. Oftentimes, merchants will sell consumer information without their permission. This is best represented when consumers receive emails from companies they don't remember subscribing to in the first place. Finally, the process of reciting your personal information (email, first and last name) in a public space is not ideal and has caused consumers to shy away from it in mass adoption.

Merchants using this system rely on consumers providing personal information with no terms of service. They are required to blindly trust that the merchant offering the email receipt option will respect their privacy over the value of selling consumer data. This has caused people to shy away from the practice.

### DESCRIPTION OF THE DRAWINGS

Some embodiments of the present invention will now be described by of example only, and with reference to the accompanying drawings, in which:

FIG. 1 is a process flow diagram illustrating an overview of the present invention;

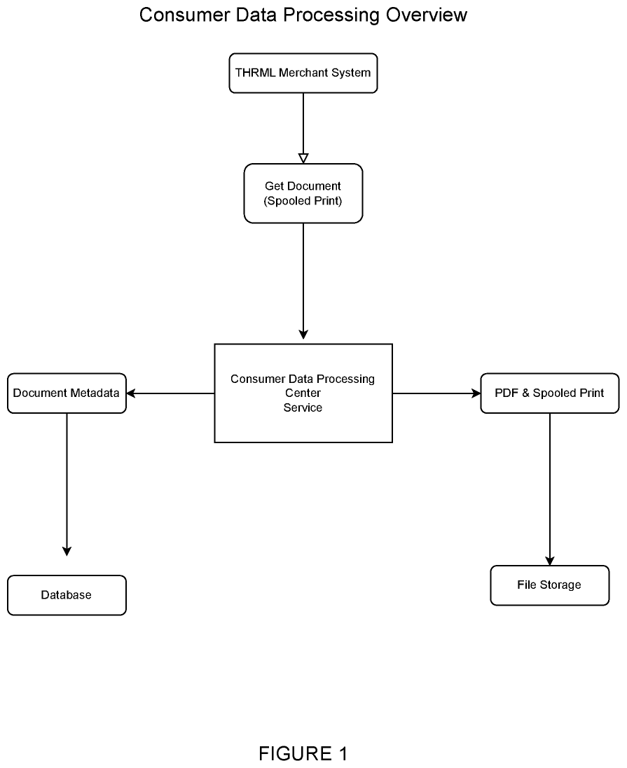

FIG. 2 is a data flow diagram illustrating the flow of data through the system of the present invention;

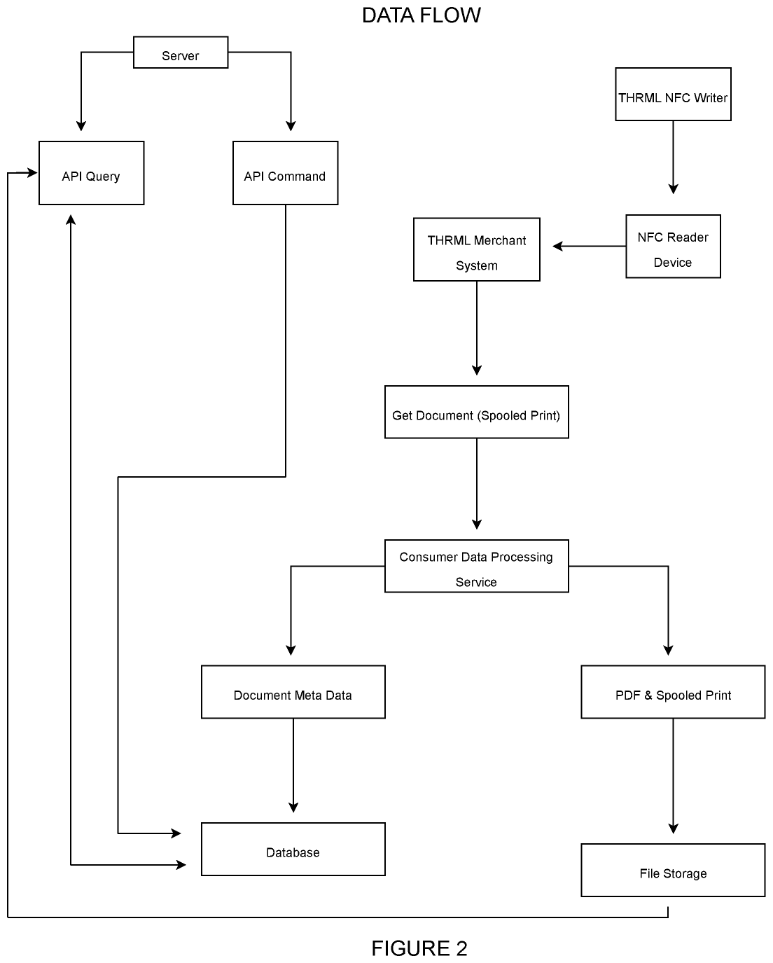

FIG. 3 is a data flow diagram illustrating further server details of the present invention;

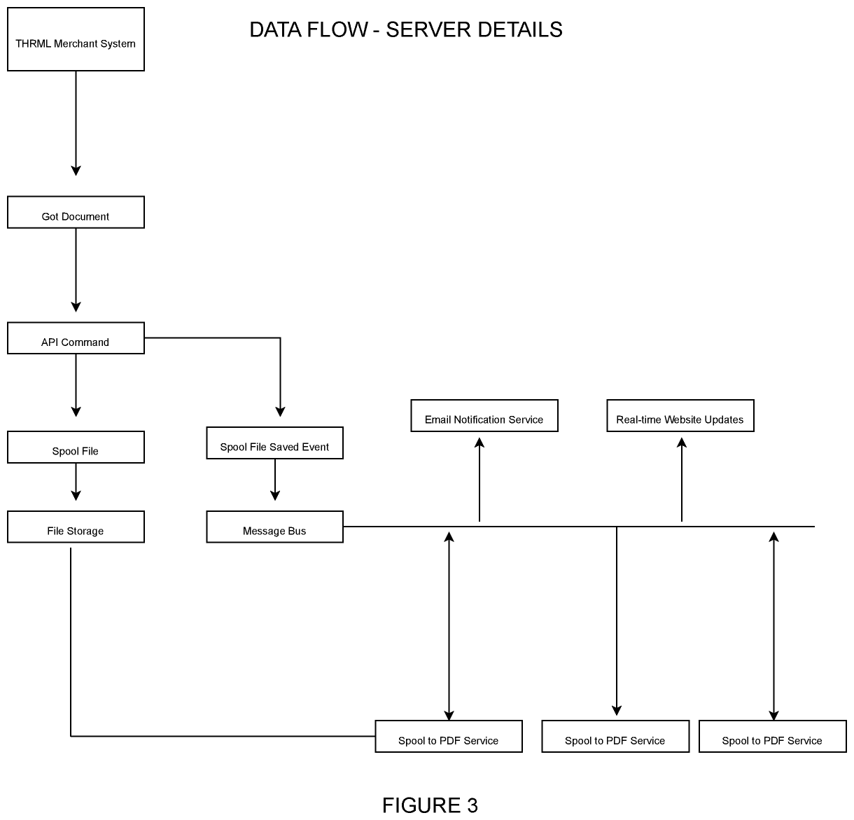

FIG. 4 is a process flow diagram illustrating the validation process of the present invention.

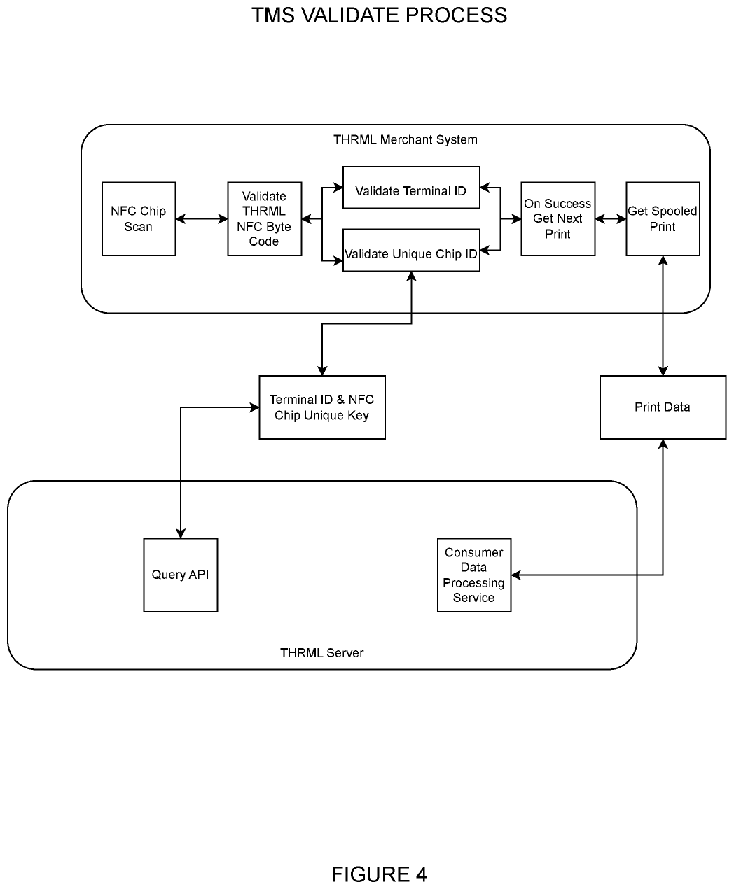

### DETAILED DESCRIPTION

The THRML Merchant System is designed with the consumer and merchant relationship in mind. The system simplifies and transforms an already antiquated practice in purchasing goods: the paper receipt. The product works in the following steps:

Identification of a transaction. As soon as a Point-of-Sale system begins registering products for sale (think scanning your bananas at the grocery store checkout), the TMS awakes, and instructs the Thermal NFC reader to begin searching for a user device.

The user scans their personalized NFC device. The consumer awaiting the goods to be scanned and bagged, taps their personalized device (either keychain, card, or e-wallet pass) on the THRML device. The TMS software, directly linked to the THRML NFC device, uses the unique code provided by the consumers personalized NFC device, and sends it via internet to the THRML server. The personalized key acts as a key for the lock on the opposing side (THRML Server). Once the account has been identified, a communication lane (think tube system at the bank, circa 2000) is created between the now open account and the transaction occurring.

The TMS software is queued for delivery. The TMS software places a hold on the top of the Merchant computer's print spool, restricting it from printing a paper receipt. The restriction remains as long as: a. A stable internet connection is maintained, and b. The lock on the server side remains open. If either of these fail, the software reverts, removing the hold on the print spool.

The consumer completes the transaction. The consumer pays for the goods, and at its completion, the receipt information is sent to the merchant computers print spool. The receipt is stopped, an exact archetype of the information is sent via the open communication line to the THRML Server, and placed in the consumer's account that corresponds with their unique NFC identification (kept on their person). Once this process is complete (taking on average less than 3 tenths of a second), a confirmation is sent to the TMS, and the stalled receipt, stationed in the print spool is wiped.

The THRML Merchant System Resets.

Operating from within the Print Spool is completely unique. Currently, all the software options for digital receipts require direct integration to point-of-sale systems, or direct integration into customer databases. Additionally, the integration of a linked hardware component is unique to payment terminals only. Oftentimes, merchants use barcode systems to identify consumers (think shoppers card circa 2000) to identify consumers. Advantages and features of preferred embodiments of the present invention include:

A) Secure storage of proof of purchase, separate from personalized email accounts, shoppers cards, and merchant applications;

B) Unique software applications for merchants that allow them to cut wasted expenses on something (i.e., the printed receipt) that is 96% likely to be discredited within 72 hours of it “use”;

C) Personalized NFC card, keychain, or e-wallet pass that grants consumers direct access to store their receipts at no cost;

D) Server software system that allows for 256 bit encryption of purchasing information, without storing banking or credit card information;

E) Direct merchant integration of digital receipt storage into specific merchant applications;

F) Streamlining emailed receipt capability; and

G) Development of specific software integration application that allows for direct sending to the THRML Server, in order to keep consumer purchasing information in house.

Appendices A and A-1 provide further technical details describing the and for implementing preferred embodiments of the present invention.

This application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms. In addition, the headings in this application are for reference purposes only and shall not in any way affect the meaning or interpretation of the present invention.

Although the foregoing text sets forth a detailed description of numerous different embodiments, it should be understood that the scope of protection is defined by the words of the claims to follow. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

### APPENDIX A

THRML Merchant Software

Proof-Of-Concept (POC)

Scope

This document contains details on:

A. Identification & documentation of potential technical issues overcome by the THRML Merchant Software.

B. Description of technical, architecture, and processes needed to produce a Minimum Viable Product.

C. Description of software and processes developed for the TMS proof-of-concept.

THRML Component Definitions

Definition of THRML Component/Products as they relate to this POC.

THRML Merchant Software (TMS)

Background software that integrates directly into a Point-of-Sale Computers. Primary responsible for reading NFC devices and transmitting print spool data to the THRML Server.

THRML Server

THRML Server, as used in this document, is a general term for describing all internet-backed backend services that support THRML's consumer-facing products. Web API endpoints, databases, etc.

THRML Server-Consumer Data Processing Service

A backend service responsible for intake and processing consumer receipt data (the spooled print job).

THRML Consumer Application

The consumer-facing endpoint allows access to their data—Web portal or App.

THRML NFC Writer

NFC device writer application for writing unique IDs to NFC devices and linking the IDs to a consumer's account.

Scenarios Identified and Evaluated

The scenarios listed below are what the POC evaluated. The POC does not implement the end-to-end flow of each scenario. Likewise, failure paths are not explicitly called out in the below scenarios.

Scenario—Create A New THRML NFC Chip

Consumer Experience

1. The consumer creates a new THRML account. Or. The consumer requests a new NFC Chip from their account portal.

2. A new THRML NFC Chip, linked to their account, arrives in the mail.

Events Produced:

1. New NFC Chip Requested. Created in step 1.

THRML NFC Writer

The THRML NFC Writer is intended for use by a THRML Employ to create a new THRML NFC Chip containing a unique Id linked to the consumer's THRM account.

THRML Employee Experience

1. The employee receives the notification of a New NFC Chip Request and a unique Id that can link a Chip to a consumers' account. (Not in scope POC. But it could be email and/or dashboard. Id created by THRML Server)

2. The employee opens THRML NFC Writer.

3. Puts an NFC Chip onto the NFC Writer hardware.

4. Enter Unique Id provide in New NFC Chip Request

5. The new NFC Chip can be mailed out and used by the consumer on successful writing.

Events Produced:

1. New NFC Chip Produced. Created in step 4.

THRML Server (Not in scope of this POC)

On New NFC Chip Requested Event:

1. Produce a new Unique chip ID (Suggest GUID/UUID) and link it to the consumer's account

2. Relay request and ID to THRML Employ On New NFC Chip Produced Event:

1. Update database to set the unique ID as enabled.

Scenario—Successful Checkout

Consumer Experience

3. The consumer begins the checkout process. ->

4. Consumer scans their unique NFC device. ->

5. The consumer completes their transaction by the delivery of payment. ->

6. The customer's receipt is accessible in their THRML account.

Events Produced:

2. NFC Chip Scanned. Created in step 2.

3. Receipt In Printer Spool. Created in step 3.

THRML Merchant Software Experience

The THRML Merchant Software waits in the background for two events: NFC Chip Scanned; and Receipt In Printer Spool.

On NFC Scanned Event

1. Read NFC ID from the device.

2. Contact THRML Server to validate the NFC ID's connection to a THRML account.

3. Flag receipt for capture.

On Receipt In Printer Spool Event with a Receipt flagged for capture

4. Pause the print job to prevent the receipt from printing.

5. Send spooled print job contents (and metadata about consumer account and merchant) to THML Server.

6. Delete print job from printer's spool.

Events Produced:

1. New Consumer Data Received. Created in step 5.

THRML Server—Consumer Data Processing Service

The THRML Server's Consumer Data Processing Service is responsible for the intake of new consumer data. On New Consumer Data Received:

1. Process data to standard file formats/sizes (PDF, JPGs thumbnails, . . . ) needed by the THRML Consumer Application.

2. Send consumer data off to primary storage.

3. Notify other THRML Server components that new consumer data is available.

Software Components Developed to POC Status

THRML NFC Writer

Overview

The Proof-Of-Concept THRML NFC Writer is a Windows application that allows writing user input IDs to an NFC chip.

The chip is also signed with a 2nd unique ID to validate the chip was programmed using a THRML NFC Writer. The 2nd unique ID is to validate a chip is for THRML without contacting the THRML Server. The 2nd unique ID allows TRHML Merchant Software to quickly and without internet access reject non-THRML NFC chips.

Usability for MVP Development

A. Backend code is a solid starting point that can be built up.

B. User Interface needs to be updated with a more modern framework.

Considerations for MVP

A. Will require THRML Server Web API to access & write user account information

B. Card Reader/Writer Backend will be built into a standard component shared with the THRML Merchant Software.

C. UI backing code should be updated to .NET LTS release.

Technology Stack

A. Windows Desktop application using Windows Presentation Foundation (WPF).

B. Uses the Model—view—viewmodel (MVVM) pattern.

C. The backing code is C# .NET.

D. Mediator pattern

E. NFC Card access makes use of the PCSC.Iso7816 standard libraries.

THRML Merchant Software

Overview

Two event monitors control the THRML Merchant Software actions: an NFC Chip Scan Monitor; and a Windows Print Spooler Monitor.

When both monitors are silent, the application sits in a waiting state for an NFC Chip Scanned event.

On an NFC Chip scan, even the application notifies the Windows Print Spooler Monitor to capture the next spooled print job and save it to disk. For the MVP, the print save event will be followed by sending the files to the THRML Server for processing.

NFC Chip Scan

The NFC Chip Scan Monitor waits for an NFC chip to be scanned. On the scan, it is in charge of doing the offline validation of the NFC chip. If the NFC chip contains the THRML unique ID, the application is notified that a new NFC chip was scanned and provided the card's unique ID for validation by the application.

Windows Print Spooler Monitor

The Windows Print Spool Monitor is only active once the application has notified it to capture the following print (in response to an NFC chip scan). Once activated, it's reasonable to catch the next spooled print.

(re-directing away from the printer hardware) and notify the application when a spooled print has been captured.

Usability for MVP Development

A. The software is a complete starting point—useful as an MVP starting project.

B. Card Reader/Writer backend should be built into a common component shared with the THRML NFC Writer application.

Considerations for MVP

A. Will require THRML Server Web API for:

B. Validate account information.

C. Send files.

D. Error reporting

E. We will need a consumer setup program for easy install.

F. It requires extensive work around system error checking and recovery.

G. It needs to handle slow or dropped network connections.

H. Handle canceled check out by the consumer.

I. Need to be run as a Windows Services for a long section of time with minor memory usage.

J. Card Reader/Writer Backend will be built into a standard component shared with the THRML NFC Writer.

Technology Stack

A. The application has two UI entry points.

B. Windows Console application

C. Windows Service

D. Backend components are independent DLLs services as defined by the application required Interfaces.

E. C# .NET Core 3.1 LTS is the main application and entry points

F. Makes use of the Windows System Event logger for error reporting.

G. NFC Card access makes use of the PCSC.Iso7816 standard libraries.

H. Print Capture interfaces with Windows using Win32.

I. Print Capture makes use of Window's “winspool.drv” exported API.

J. Makes use of Clean Architecture aspects for infrastructure serves and dependency order.

K. Inversion of Control (IoC) dependency injection setup by the application entry point defined by the core application DLL public services interfaces.

THRML Server—Consumer Data Processing Service

Overview

The THRML Server Consumer Data Processing Service processes consumer receipt data (the spooled print job). The POC is capable of handling XPS print formats.

Usability for MVP Development

A. It shows how to open the spool and meta file.

Considerations for MVP

A. It needs to be re-written into containerized services for server hosting.

B. It requires a plugin setup for supporting many print spool formats.

C. It should be file system agnostic to move from S3 and Azure Blob storage.

NFC

Technology Review

RFID Overview

RFID can use anything from Low Frequency (LF) 1205-143 kHz, High Frequency (HC) 13.56 MHz, and Ultra High Frequency (UHF) 856 MHz-960 MHz.

The first proximity technologies used 125 kHz. When a 125 kHz card—commonly referred to as ‘Prox’ cards—comes within range of a reader, the card immediately begins to transmit its card number. The data transmitted by the card is not encrypted and is always the same. Data transfer is only one way—like how older mag-stripe readers worked.

Prox cards offers a good read range (of around 3 in) and a short-read time. Making them good for things like asset tags that can go inside of packages.

However, the low level of security and one way communication, and they seem to be going out of style in consumer goods.

NFC Overview

NFC uses a subset of RFID bands, specifically the High Frequency (HC.) Radio band at 13.56 MHz.

The 13.56 MHz MIFARE standard was originally created as a ticketing solution for transport systems, while also addressing the security issues with 125 kHz technology by enabling two-way communication between the card and reader. This saw the introduction of card encryption and the ability to store data on the card.

When the card is pressed to a card, the reader begins a secure communication session using a shared encryption key. Once this is established, the card number is transmitted, and the communication session is closed off. This process happens very quickly; however, it does take slightly longer than a 125 kHz based system

NFC is commonly used in consumer goods, including Contactless Payment. Because of Contactless Payment, Most Smart Phones have NFC reader/writer build in. So, it's posable to build a phone app that can act as a virtual NFC card.

NFC Cards/Chips

Durable

10 years (NTAG21x, MIFARE Classic®, MIFARE Plus®, MIFARE Ultralight®, MIFARE® DESFire® EV1, MIFARE® DESFire® Light)

25 years (MIFARE® DESFire® EV2)

50 years (ICODE® SLIX, ICODE® SLIX2, ICODE® DNA)

200 years (ST25TA)

Encryption

Without encryption, the content of the chip is “in the clear”, visible to anyone who scans the tag with their smartphone or NFC reader. To avoid this, you need to choose a chip that supports encryption. Below, the Chips with this feature, in ascending order of security of the supported cryptographic methods.

MIFARE Classic (CRYPTO01)

MIFARE DESFire EV1/EV2/Light (DES, 2K3DES, 3K3DES, AES) MIFARE Plus/ICODE DNA (AES 128 bit)

MIFARE Ultralight C (3DES)

NTAG413 DNA/NTAG424 DNA (CMAC based on AES)

Recommendations

Reader/Writer

Most RFID 13.56MHz Reader/Writer that is recognized by Windows 10 as a smart card device will work. I have had good success with:

ETEKJOY ACR122U NFC RFID 13.56 MHz Contactless Smart Card Reader/Writer

USB_1600376035681.html

Cards/Chips

The 13.56 MHz MIFARE Classic 1K Rewritable chips work well and can be found at the best price point.

Print Interception

Technology Review

There are many ways to capture contents from an application printing process. The three identified and considered are: Create A Customer Printer Driver, A Custom Printer Port, and Monitor a Printers Spool.

Create A Custom Printer Driver

A THRML Windows Printer Driver would be created and assigned as the POS system's default Printer. The driver would then send the receipts to an actual printer or THRML Merchant Software, depending on if a card was swiped or not.

This option was considered but ultimately was too heavy-handed for our needs. It would involve processing every print on the computer, whether it was intended for THRML or not. Likewise, the install process would require the user not to use their printer's driver as their default printer.

Custom Printer Port

Windows allows spooled prints to be sent to a specific system port. In pre-Windows 10 DDK's, there was a way to create a custom port and port monitor. Having the spooled print job be sent to a new port would allow THRML components to

This option didn't work out well as with the later Windows DDKs, the ability to monitor the port and all documentation have been removed.

Print Spool Monitoring

Monitor a printer's Spooler for change events and control the printer job's state (Paused, cancel, resume) using the Spooler.dry API allows us to detect when a receipt is printing without accessing the content of the print job.

Print Spool Formats

For each print job there are two spool files generated by the Windows NT/2000 spooler. One file with the. SHD extension for job settings, and one with the. SPL extension for the drawing commands.
SPL Microsoft Windows Spool File Format
SHD Microsoft Windows Shadow File Format

The print spooler file can be a large verity of formats (see format list below).

However, they are typically grouped into two formats to call RAW-SPL and the EMF-SPL.

RAW-SPL:

In the case of RAW data, the content of the file is the same as the data send to the printer. So, this data could be XPS, PCL, PostScript, ESC-P, CaPSL, Prescribe or similar.

EMF-SPL:

EMF stands for Enhanced Metafile. the SPL files consist of one or more standard EMF files, surrounded by some extra records. The EMF SPL files contain a special version of EMF, not compatible with standard EMF,

although most of the records are the same. There is more information about EMF in the Windows Platform SDK.

Know formats:
AFP—Advanced Function Printing
AFPDS—IBM Advanced Function Presentation Data Stream
ART—Xerox Advanced Rendering Tools
HBP—Brother Host Based Printing
Brother NCM (Brother Native Compression Mode)
Brother Type 3 Metalanguage (Brother Laser Printer Bitmap)
Brother P-Touch
Canon BJL
Canon UFR (Canon Ultra Fast Rendering)
CAPT (Canon Advanced Printing Technology)
CaPSL - Canon Printing System Language (See also LIPS)
Code-V—QMS Magnum Code-V (QMS)
CPCL Comtec Printer Control Language (Zebra, Comtec)
CPL (Tally Compressed Printer Language)

DDIF (Digital Document Interchange Format)

Diablo 630

DPL—Datamax Programming Language Datamax Programming Language

DSC-DSE (DSC-DSE: Data Stream Compatible and Emulation Bi-directional print data stream for non-SNA (DSC) and SNA LU-3 3270 controller (DSE) communications)

EPCL Eltron Printer Command Language (Zebra, Eltron)

EPL1—Eltron/Zebra Programming Language 1

EPL2 Eltron Programming Language 2, Page Mode Printing (Zebra, Eltron)

Epson 3/P/Si

Epson FX.

Epson GL.

Epson GL2

Epson LQ

ESC/P—Epson Standard Code for Printers

ESC/P2—Epson Standard Code for Printers, Level 2

EXCL (Talaris Systems, Extended Command Language)

GIPD—Granite Image Printer Driver Used by some Lexmark (X500) and Dell (MFP 1125) GDI printers

HBPL—Dell, Epson, and Fuji-Xerox Printer Language Used by SLED laser printers from Dell (1250c, etc.), Epson (C1700, etc.) and Fuji-Xerox (cp105b, etc.)
Hiper-C (OKI Hiper-C)
IBM 5577 Used by IBM 5577 (Japanes) (Also known as Ricoh R55)
IBM ASCII Later renamed to PPDS - IBM Personal Printer Data Stream
IBM I239X Used by IBM 2390/2391
IDP (Apple, Imaging Device Protocol)
IGP (Printronix Corp.)
IMF—Zenographics SuperPrint/SuperRip spool file format
Interpress Xerox predecessor to PostScript
IPDS
IPL Intermec Programming Language
ISO6429 Control functions for Coded Character Sets (ISO/IEC DIS 6429)
ISO10180 SPDL—Standard Page Description Language (ISO/IEC DIS 10180)
JetReady (HP JetReady)
KPDL (Kyocera's own implementation of PostScript)
LAVAFLOW—Zenographics PCL (Zenographics inplementation of PCL—HP Page Description Language)
LCDS—Xerox Line Conditioned Data Stream (Xerox, Line Conditioned Data Stream)
LIDIL (HP Lightweight Imaging Device Interface Language)
LineData
LIPS—Canon Laser-beam Image Processing System
Metacode—Xerox Xerox LPS printers
MO:DCA—IBM Mixed Object Document Content Architecture
NEC PC-PR201H NEC (Japanes)
NEC201PL NEC (Serial printer language used in the Japanese market)
NPDL NEC (Page printer for Japanese market)
OAKT (Oak Technology (now Zoran))
OKI GDI
OPL Konica Minolta 2480MF
Pages (IBM Japan, Page printer Advanced Graphic Escape Set)
PCL—HP Page Description Language
PCL3GUI
PCL XL—HP Page Description Language Level 6
PDF/A
PDF/X
PGL (Printronix Graphics Language)
Pinwriter (NEC Pinwriter, 24 wire dot matrix printer)
PPA—HP Printing Performance Architecture
PPDS—IBM Personal Printer Data Stream
PostScript
Prescribe
ProPrinter—IBM ProPrinter
QPDL—Quick Page Description Language (Samsung Printer Language II/QPDL)
ReGIS (Remote Graphics Instruction Set, Digital Equipment Corp.)
RENO
RPCS—Ricoh Refined Printing Command Stream
RPDL—Ricoh Page Description Language
RTL—HP Raster Transfer Language
Sagem GDI Used by Ricoh SP1000s and SP1100s
SAP (SAP OTF data stream)
SAP-ABAP (SAP Advanced Business Application Programming)
SCP—HP Sleek Control Protocol
SCS—SNA Character String
SLX Used by the Lexmark c500n. (Software Imaging KK.)
SMART (Samsung SMART)
SPDL Standard Page Description Language (ISO/IEC DIS 10180)
SPL—Samsung Printer Language (Samsung Printer Language)
SVG Print
TEK4014 (Tektronix Corp.)
WPS (Windows Printing System, Resource based command/data stream used by Microsoft At Work Peripherals)
XHTML Print
XL2HB—Brother PCL XL like PDL
XES (Xerox Escape Sequences)
XPS—XML Paper Specification
XQX Used by the Hewlett-Packard LaserJet M1005
XSL-FO
ZIMF (Zenographics ZIMF)
ZjStream—Zenographics SuperPrint Zj Stream
ZPL1 Zebra Programming Language
ZPL2 Zebra Programming Language II

Recommendations

Printer spool monitoring is the best option for capturing a print's contents in a less intrusive, secure, and flexible manner.

Likewise, it's recommended to not process the print spooler contents on the client's system. Instead sending the spooler contents to be analyzed on the THRML server.

Print Spool Format Converters

Sending the Print Spooler to the THRML Server allows the flexibility to continually add support for different print spooler formats without updating the client software. As different printers and systems can use a variety of spooler formats, it's best to add support for a few standard forms and then only add specific support for less common formats, when you want to support a printer/model that uses that format.

Standard formats to consider supporting:
XPS—https://en.wikipedia.org/wiki/Open_XML_Paper_Specification
A PDL Format like PostScript PCL, or PCL6. https://en.wikipedia.org/wiki/Page_description_language, https://en.wikipedia.org/wiki/Printer_Command_Language
   Using open-source converters or comical product like GhostScript PDL
EMF—https://en.wikipedia.org/wiki/Windows_Metafile#EMF
Epson Standard Code (ESC/P2 or ESC/P)—https://en.wikipedia.org/wiki/ESC/P

THRML Merchant Software (TMS) is designed to integrate directly into a Point Of Sale Computers running on the Windows operating system. TMS operated as a background program connected via hardware to the Thermal NFC Hardware utilized by consumers and wirelessly to the Thermal Server via ethernet connection to the POS computer.

TMS has the key responsibility of receiving data from the NFC hardware, and sending the individualized number assigned to the THRML server via ethernet. Upon matching the individualized number received from the NFC product to the account information stored in the THRML server, TMS executes the following action:

TMS activates an auto-grab function from the top of the print spool, recreates the information into a congruent archetype hosting all the key information provided on the consumer receipt and delivers the archetype to the corresponding consumer account located on the THRML Server, via the ethernet connection connected to the merchant computer.

The Process

1. 2. 3.

4. 5. 6.

7.

Responsibilities
NFC Integration
Print Spool Integration
Server Connectivity

THRML TECHNOLOGIES© CONFIDENTIAL

THRML System
NFC Touchpoint
USB Connectivity
Hardware to Software Attachment
Uniquely simple
Resembles wireless charging circle
User Facing
Modern, Organized
Security Structure mirroring a banking application
Collated receipt information, organized by date, category, etc.
Accessible, for
Ordering/Reordering Card Caple

Background Software
Simple Setup
Root Access
Print Spool Focused
Auto-run behinds POS programs
Functional in Windows
Server Access
USB Connection
Backlog Capability up to 1000 transactions
Auto draw receipt in case of backlog storage
Consumer to Merchant Connection Point
Data Storage for Consumer
Sorted and organized based on individual ID
256 Bit Encryption

[symbol]

CONFIDENTIAL THRML TECHNOLOGIES 0

[symbol]

When constructing the software product known as THRML Merchant Software, there will be a host of required products. These include:
A computer running Windows Operating System
Open source Point-of-Sale System
Near Field Communication Reader
Near Field Communication Card/Device/E-pass
Thermal Printer
Internet Connection, via Ethernet
A Payment Terminal (Optional)

Open source Point-of-Sale System

An open source POS system will allow for more flexibility when constructing the initial TMS prototype. Odoo, OSPOS, or SambaOS are all possible products of which can be built atop. Links are provided to their websites (here, here, and here, respectively). The POS system will act as the baseplate upon which the software framework will be constructed.

Near Field Communication Reader

The near field communication reader will be required to interface directly with TMS to initiate the linkage between the NFC Reader and the THRML Server, of which TMS will be responsible. TMS will receive the information provided by the NFC, authenticate it with the THRML Server via ethernet connection on the merchant computer, and open the pathway of transmission which will utilize to transport the archetype.

Near Field Communication Card/Device/E-Pass

The near field communication device will hold the individual code associated with the corresponding account in the THRML server. The responsibility of the device is to allow TMS to begin the communication process, and open a lane for data transmission.

Thermal Printer

A thermal printer will be preferred to ensure that if the device is not able to create a functioning pathway for the transmission of information, the receipt from the transaction is printed. The thermal printer will act as a failsafe.

Milestones

I. Verify connection between TMS and the NFC Reader

II. Verify connection between TMS and the THRML Server

III. Verify connection between TMS and the POS System

IV. Verify unique account identification ability by TMS through the liaison function, using information provide by the NFC Reader, and matching it with corresponding information in the THRML server

V. Execute the transmission of data from the Merchant Computer Print Spool to the THRML Server through “auto-grab” automation

VI. Ensure that the archetype created from the information captured from the print spool still holds all the key characteristics post transmission

VII. Incorporate the “and erase” function following the “auto-grab” function from the print spool

THRML Merchant Software

Overview

Two event monitors control the THRML Merchant Software actions: an NFC Chip Scan Monitor; and a Windows Print Spooler Monitor.

When both monitors are silent, the application sits in a waiting state for an NFC Chip Scanned event.

On an NFC Chip scan, even the application notifies the Windows Print Spooler Monitor to capture the next spooled print job and save it to disk. For the MVP, the print save event will be followed by sending the files to the THRML Server for processing.

NFC Chip Scan

The NFC Chip Scan Monitor waits for an NFC chip to be scanned. On the scan, it oversees doing the offline validation of the NFC chip. If the NFC chip contains the THRML unique ID, the application is notified that a new NFC chip was scanned and provided the card's unique ID for validation by the application.

Windows Print Spooler Monitor

The Windows Print Spool Monitor is only active once the application has notified it to capture the following print (in response to an NFC chip scan). Once activated, it's reasonable to catch the next spooled print.

(re-directing away from the printer hardware) and notify the application when a spooled print has been captured.

Usability for MVP Development

A. The software is a complete starting point—useful as an MVP starting project.

B. Card Reader/Writer backend should be built into a common component shared with the THRML NFC Writer application.

Considerations for MVP

A. Will require THRML Server Web API for:

a. Validate account information.

b. Send files.

c. Error reporting

B. We will need a consumer setup program for easy install.

C. It requires extensive work around system error checking and recovery.

D. It needs to handle slow or dropped network connections.

E. Handle canceled check out by the consumer.

F. Need to be run as a Windows Services for a long section of time with minor memory usage.

G. Card Reader/Writer Backend will be built into a standard component shared with the THRML NFC Writer.

Technology Stack

A. The application has two UI entry points.

a. Windows Console application

b. Windows Service

B. Backend components are independent DLLs services as defined by the application required Interfaces.

C. C# .NET Core the main application and entry points

D. Makes use of the Windows System Event logger for error reporting.

E. NFC Card access makes use of the PCSC.Iso7816 standard libraries.

F. Print Capture interfaces with Windows using Win32.

G. Print Capture makes use of Window's “winspool.drv” exported API.

H. Makes use of Clean Architecture aspects for infrastructure serves and dependency order.

I. Inversion of Control (IoC) dependency injection setup by the application entry point defined by the core application DLL public services interfaces.

THRML Server—Consumer Data Processing Service

Overview

The THRML Server Consumer Data Processing Service processes consumer receipt data (the spooled print job). The POC is capable of handling XPS print formats.

Usability for MVP Development

A. It shows how to open the spool and meta file.

Considerations for MVP

A. It needs to be re-written into containerized services for server hosting.

B. It requires a plugin setup for supporting many print spool formats.

C. It should be file system agnostic to move from S3 and Azure Blob storage.

NFC

Technology Review

RFID Overview

RFID can use anything from Low Frequency (LF) 1205-143 kHz, High Frequency (HC) 13.56 MHz, and Ultra High Frequency (UHF) 856 MHz-960 MHz.

The first proximity technologies used 125 kHz. When a 125 kHz card—commonly referred to as ‘Prox’ cards—comes within range of a reader, the card immediately begins to transmit its card number. The data transmitted by the card is not encrypted and is always the same. Data transfer is only one way—like how older mag-stripe readers worked.

Prox cards offers a good read range (of around 3 in) and a short-read time. Making them good for things like asset tags that can go inside of packages.

However, the low level of security and one way communication, and they seem to be going out of style in consumer goods.

NFC Overview

NFC uses a subset of RFID bands, specifically the High Frequency (HC.) Radio band at 13.56 MHz.

The 13.56 MHz MIFARE standard was originally created as a ticketing solution for transport systems, while also addressing the security issues with 125 kHz technology by enabling two-way communication between the card and reader. This saw the introduction of card encryption and the ability to store data on the card.

When the card is pressed to a card, the reader begins a secure communication session using a shared encryption key. Once this is established, the card number is transmitted, and the communication session is closed off. This process happens very quickly; however, it does take slightly longer than a 125 kHz based system.

NFC is commonly used in consumer goods, including Contactless Payment. Because of Contactless Payment, Most Smart Phones have NFC reader/writer build in. So, it's posable to build a phone app that can act as a virtual NFC card.

NFC Cards/Chips

Durable

10 years (NTAG21x, MIFARE Classic®, MIFARE Plus®, MIFARE Ultralight®, MIFARE® DESFire® EV1, MIFARE® DESFire® Light)

25 years (MIFARE® DESFire® EV2)

50 years (ICODE® SLIX, ICODE® SLIX2, ICODE® DNA)

200 years (ST25TA)

Encryption

Without encryption, the content of the chip is “in the clear”, visible to anyone who scans the tag with their smartphone or NFC reader. To avoid this, you need to choose a chip that supports encryption. Below, the Chips with this feature, in ascending order of security of the supported cryptographic methods.

MIFARE Classic (CRYPTO01)

MIFARE DESFire EV1/EV2/Light (DES, 2K3DES, 3K3DES, AES) MIFARE Plus/ICODE DNA (AES 128 bit)

MIFARE Ultralight C (3DES)

NTAG413 DNA/NTAG424 DNA (CMAC based on AES)

Recommendations

Reader/Writer

Most RFID 13.56 MHz Reader/Writer that is recognized by Windows 10 as a smart card device will work. I have had good success with:

ETEKJOY ACR122U NFC RFID 13.56 MHz Contactless Smart Card Reader/Writer

Cards/Chips

The 13.56 MHz MIFARE Classic 1K Rewritable chips work well

Print Interception

Technology Review

There are many ways to capture contents from an application printing process. The three identified and considered are: Create A Customer Printer Driver, A Custom Printer Port, and Monitor a Printers Spool.

Create A Custom Printer Driver

A THRML Windows Printer Driver would be created and assigned as the POS system's default Printer. The driver would then send the receipts to an actual printer or THRML Merchant Software, depending on if a card was swiped or not.

This option was considered but ultimately was too heavy-handed for our needs. It would involve processing every print on the computer, whether it was intended for THRML or not. Likewise, the install process would require the user not to use their printer's driver as their default printer.

Custom Printer Port

Windows allows spooled prints to be sent to a specific system port. In pre-Windows 10 DDK's, there was a way to create a custom port and port monitor. Having the spooled print job be sent to a new port would allow THRML components to

[symbol]

This option didn't work out well as with the later Windows DDKs, the ability to monitor the port and all documentation have been removed.

Print Spool Monitoring

Monitor a printer's Spooler for change events and control the printer job's state (Paused, cancel, resume) using the Spooler.dry API allows us to detect when a receipt is printing without accessing the content of the print job.

Print Spool Formats

For each print job there are two spool files generated by the Windows NT/2000 spooler. One file with the. SHD extension for job settings, and one with the. SPL extension for the drawing commands.
SPL Microsoft Windows Spool File Format
SHD Microsoft Windows Shadow File Format

The print spooler file can be a large verity of formats (see format list below).

However, they are typically grouped into two formats to call RAW-SPL and the EMF-SPL.

RAW-SPL:

In the case of RAW data, the content of the file is the same as the data send to the printer. So, this data could be XPS, PCL, PostScript, ESC-P, CaPSL, Prescribe or similar.

EMF-SPL:

EMF stands for Enhanced Metafile. the SPL files consist of one or more standard EMF files, surrounded by some extra records. The EMF SPL files contain a special version of EMF, not compatible with standard EMF,

although most of the records are the same. There is more information about EMF in the Windows Platform SDK.

Know formats:
AFP—Advanced Function Printing
AFPDS—IBM Advanced Function Presentation Data Stream
ART—Xerox Advanced Rendering Tools
HBP—Brother Host Based Printing
Brother NCM (Brother Native Compression Mode)
Brother Type 3 Metalanguage (Brother Laser Printer Bitmap)
Brother P-Touch
Canon BJL
Canon UFR (Canon Ultra Fast Rendering)
CAPT (Canon Advanced Printing Technology)
CaPSL—Canon Printing System Language (See also LIPS)
Code-V—QMS Magnum Code-V (QMS)
CPCL Comtec Printer Control Language (Zebra, Comtec)
CPL (Tally Compressed Printer Language)
DDIF (Digital Document Interchange Format)
Diablo 630
DPL—Datamax Programming Language Datamax Programming Language
DSC-DSE (DSC-DSE: Data Stream Compatible and Emulation Bi-directional print data stream for non-SNA (DSC) and SNA LU-3 3270 controller (DSE) communications)
EPCL Eltron Printer Command Language (Zebra, Eltron)
EPL1—Eltron/Zebra Programming Language 1
EPL2 Eltron Programming Language 2, Page Mode Printing (Zebra, Eltron)
Epson 3/P/Si
Epson FX.
Epson GL.
Epson GL2
Epson LQ
ESC/P—Epson Standard Code for Printers
ESC/P2—Epson Standard Code for Printers, Level 2
EXCL (Talaris Systems, Extended Command Language)
GIPD—Granite Image Printer Driver Used by some Lexmark (X500) and Dell (MFP 1125) GDI printers
HBPL—Dell, Epson, and Fuji-Xerox Printer Language Used by SLED laser printers from Dell (1250c, etc.), Epson (C1700, etc.) and Fuji-Xerox (cp105b, etc.)
Hiper-C (OKI Hiper-C)
IBM 5577 Used by IBM 5577 (Japanes) (Also known as Ricoh R55)
IBM ASCII Later renamed to PPDS—IBM Personal Printer Data Stream
IBM I239X Used by IBM 2390/2391
IDP (Apple, Imaging Device Protocol)
IGP (Printronix Corp.)
IMF—Zenographics SuperPrint/SuperRip spool file format
Interpress Xerox predecessor to PostScript
IPDS
IPL Intermec Programming Language
ISO6429 Control functions for Coded Character Sets (ISO/IEC DIS 6429)
ISO10180 SPDL—Standard Page Description Language (ISO/IEC DIS 10180)
JetReady (HP JetReady)
KPDL (Kyocera's own implementation of PostScript)
LAVAFLOW—Zenographics PCL (Zenographics inplementation of PCL—HP Page Description Language)
LCDS—Xerox Line Conditioned Data Stream (Xerox, Line Conditioned Data Stream)
LIDIL (HP Lightweight Imaging Device Interface Language)
LineData
LIPS—Canon Laser-beam Image Processing System
Metacode—Xerox Xerox LPS printers
MO:DCA—IBM Mixed Object Document Content Architecture
NEC PC-PR201H NEC (Japanes)
NEC201PL NEC (Serial printer language used in the Japanese market)
NPDL NEC (Page printer for Japanese market)
OAKT (Oak Technology (now Zoran))
OKI GDI
OPL Konica Minolta 2480MF
Pages (IBM Japan, Page printer Advanced Graphic Escape Set)
PCL—HP Page Description Language
PCL3GUI
PCL XL—HP Page Description Language Level 6
PDF/A
PDF/X
PGL (Printronix Graphics Language)
Pinwriter (NEC Pinwriter, 24 wire dot matrix printer)
PPA—HP Printing Performance Architecture
PPDS—IBM Personal Printer Data Stream
PostScript
Prescribe
ProPrinter—IBM ProPrinter
QPDL—Quick Page Description Language (Samsung Printer Language II/QPDL)
ReGIS (Remote Graphics Instruction Set, Digital Equipment Corp.)
RENO
RPCS—Ricoh Refined Printing Command Stream
RPDL—Ricoh Page Description Language
RTL—HP Raster Transfer Language
Sagem GDI Used by Ricoh SP1000 s and SP1100s
SAP (SAP OTF data stream)
SAP-ABAP (SAP Advanced Business Application Programming)
SCP—HP Sleek Control Protocol
SCS—SNA Character String
SLX Used by the Lexmark c500n. (Software Imaging KK.)
SMART (Samsung SMART)
SPDL Standard Page Description Language (ISO/IEC DIS 10180)
SPL—Samsung Printer Language (Samsung Printer Language)
SVG Print
TEK4014 (Tektronix Corp.)
WPS (Windows Printing System, Resource based command/data stream used by Microsoft At Work Peripherals)
XHTML Print
XL2HB—Brother PCL XL like PDL
XES (Xerox Escape Sequences)
XPS—XML Paper Specification
XQX Used by the Hewlett-Packard LaserJet M1005
XSL-FO
ZIMF (Zenographics ZIMF)
ZjStream—Zenographics SuperPrint Zj Stream
ZPL1 Zebra Programming Language
ZPL2 Zebra Programming Language II

Recommendations

Printer spool monitoring is the best option for capturing a print's contents in a less intrusive, secure, and flexible manner.

Likewise, it's recommended to not process the print spooler contents on the client's system. Instead sending the spooler contents to be analyzed on the THRML server.

Print Spool Format Converters

Sending the Print Spooler to the THRML Server allows the flexibility to continually add support for different print spooler formats without updating the client software. As different printers and systems can use a variety of spooler formats, it's best to add support for a few standard forms and then only add specific support for less common formats, when you want to support a printer/model that uses that format.

Standard formats to consider supporting:
XPS—https://en.wikipedia.org/wiki/Open_XML_Paper_Specification
A PDL Format like PostScript PCL, or PCL6. https://en.wikipedia.org/wiki/Page_description_language, https://en.wikipedia.org/wiki/Printer_Command_Language

Using open-source converters or comical product like GhostScript PDL
EMF—https://en.wikipedia.org/wiki/Windows_Metafile#EMF
Epson Standard Code (ESC/P2 or ESC/P)—https://en.wikipedia.org/wiki/ESC/P

THRML Server: Consumer

Data Processing Service

Overview

Summary

The THRML Server Consumer Data Processing Service is responsible for intaking spooled print jobs, saving information about the print data, saving the print spool to long term cloud storage, and convert the spooled print to a common file format (PDF) for outer services to use.

Document Definitions

THRML Server

THRML Server, as used in this document, is a general term for describing all internet-backed backend services that support THRML's consumer-facing products. Web API endpoints, databases, etc.

THRML Server—Consumer Data Processing Service

The focus of this document. A backend service responsible for intake and processing consumer receipt data (the spooled print job).

THRML Server THRML Server—Command API

A backend service responsible for processing user commands related to writing to the database and storage of files. “Create New Card ID”, “Report Terminal Error”, etc.

THRML Merchant Software (TMS)

Background software that integrates directly into a Point-of-Sale Computers. Primary responsible for reading NFC chip and transmitting print spool data to this THRML Server—Consumer Data Processing Service.

Architectural Details

REST API—ReportSpoolData

The THRML Server—Consumer Data Processing Service provides a single REST API endpoint (ReportSpoolData) to be used by the THRML Merchant Software. When the API is called with valid data, the SpoolDataReportedEvent application event is produced.

It is expected that the THRML Server—Command Services may replace this API Endpoint in later releases. Input: Base64File and File Metadata:

{Id: Guid, CreatedAt: DateTime, CardId: Guid, TerminalId: Guid, PrinterName: string, PrintProcessor: string, PrintDataType: string}

Application Events

SpoolDataReportedEvent

The SpoolDataReportedEvent is produced when the THRML Merchant Software Reports new spool data.

The application handles the event by persisting the print spool data (and Metadata) to print spool file storage.

Once the spool data is saved, the SpoolDataAvalableEvent application event is produced.

SpoolDataAvalableEvent

The SpoolDataAvalableEvent is expected to be the entry into the THRML Server Consumer Data Processing Service if the THRML Server—Command Services takes over Persisting spooler data in later release.

The application handles this event by:

1. Read Metadata to decide what format the spool file is in

a. If Processer=MS_XPS_PROC then use XPS convert is used

b. If Processer=RAW and DataType is EMF then EMF converter is used

c. If Processer=RAW and DataType is PDL then PDL convert can is set

2. Send the spooled print int the appropriate converter

3. Save output file from convert to Common File Storage

Once the common file (PDF) is saved to storage, the integration Event CommonFileCreated is sent the THRML Server ecosystem for processing.

Print Spool Converter

The print spool converters are responsible for taking a Windows spooled print file (.SPL) and converting it to the common file format (.PDF) that will be used as the main file in the THRML ecosystem.

EMF Print Spool to Common EMF File

The Windows spool file is held in the raw printer page definition language (which could be PCL, PostScript or one of many other options See the POC document for good list of formats.) but Windows 2000 and newer it is possible to have the spooler use a more device independent format known as an EMF spool file.

The file layout of an EMF spool file looks to be different than common EMF files understood by a document rendering tools. To give us better options for working with the EMF file we extra the main EMF layout for the spool file and save the data as a true EMF file that can then be converted to PDF by a large verity of common tools.

Reference for EMF: https://docs.microsoft.com/en-us/openspecs/windows_protocols/ms-emfspool/3d8cd6cc-5287-42e8-925f-4a53afd04534

Common EMF to PDF

To convert from EMF to the common file format, PDF, we may use of LibreOffice with the calc_pdf_Export exporter.

XPS/PDL To PDF

The print spool files with Processer=MS_XPS_PROC are in standard XPS format and just need to be extracted and then converted to PDF. There are many common tools on Linux to do the conversion such as libxps-utils or ocular, however we picked the community version of Ghost Script to evaluate the need as it will also handle PostScript conversion without more tools installed. Depending on THRML install base and the type of print formats we see, this convert can be moved to a different tool or retired if not used.

Storage

Metadata Storage

Print spool metadata is a key/value pares of standard types that can be stored any modern format. For the MVP we are saving the data into SQL server the THRML Server components will most likely use SQL as their data storage.

Print Spool/Common File Storage

The print spool file, once converted, can live in any long-term storage as it doesn't need to be access often.

The Common File should need to be stored in a quick access storage for other servers, include the THRML Consumer Application to access it quickly.

In both cases we decided to use Amazon Simple Storage Service (Amazon S3) because it has become the standard for object storage services that offers industry-leading scalability, data availability, security, and performance.

The S3 Standard has been adopted by all large storage providers. To avoid lock-in to AWS for storage, we are not using the AWS SDK for file access. Instead, we are using the Minio S3 client to provide better access to other S3 providers.

Hosting/Providers

Computer Hosting: Azure (Microsoft) Metadata Storage: Azure (Microsoft) File Storage: AWS (Amazon)

Printer Settings

Enable Advanced Print Features

When this setting is enabled print jobs are typically spooled in the EMF format. This setting allows spooled data send to the THRML Server Consumer Data Processing Service to be more consistent.

With this setting disabled, print jobs are spooled in a RAW format, which could be a verity of formats. Typical formats are XPS, PostScript, EMF, printer's native language, or 100+ different formats.

When posable “Enable Advanced Print Features” should be enabled to allow minimize the file formats that the THRML Server Consumer Data Processing Service needing to support.

Note on some Windows Version this setting maybe called “Always spool in RAW” and should be disabled on such systems.

Logging

The THRML Server Consumer Data Processing Service logs the system console using the Microsoft.Extensions.Logging default setting. Logs can be found using App Service file system or Azure Storage blobs.

Project Layout

The THRML Server Consumer Data Processing Service is based on a service architecture borrowing from Clean Architecture with business logic being self-contained within a single application project (.NET Core DLL).

Application layer defined all in interfaces needed to perform domain specific tasks. The top-level UI layer (.Net Core Web API) is responsible for Dependency Injection setup for each service. All other interfaces service implementation is responsible for their select tasks. Communication from the UI layer to the Application is done using the Mediator pattern for events.

Technology Stack

Programing Languages

C# .NET Core

ReactJS/TypeScript

Bash

Python 3

Software Dependencies

MediatR—Used to decouple the in-process sending of messages from handling messages.

Docker—Used to package the application for deploy on to cloud servers

Libgdiplus is the Mono library that provides a GDI+-compatible API to Linux.

Libreoffice—the Linux office sweet used to convert EMF to PDF

System Hardware Requirements

1. The THRML Server Consumer Data Processing Services is designed to run on Small or XSmall cloud compute resource. At the time of this writing, all THRML Server components are successfully running on Azure B 1: 1 App service plan (100 ACU, 1.75 GB memory, A-Series Computer).

System Software Requirements

1. Capable for running Linux Docker Containers.

Packaging

Docker Container

The THRML Server Consumer Data Processing Services is built as a docker container built around mcr.microsoft.com/dotnet/aspnet:6.0 Linux base with wget, libgdiplus, libreoffice, and gxps installed.

Supportability

Logging

The THRML Merchant Software logs to two end points when running as a service: Windows Event Logger; and the THRML Server—Command API.

When running as a standalone application all logging is ALSO displayed in the console UI. See ‘Logging’ under the ‘Architectural Details’ section for more information.

Future Opportunities

Consolidate Server Actions

The TMS MVP is calling into THRML Server-Consumer Data Processing Service directly. As the THRML Server architecture becomes finalized, it's likely that the TMS should only relay on the Command and Query APIs.

Monitor Printer Spool Formats

These services convert the primary print spool formats that we expect to see with our specific install base. However, there is many formats that we may see in the real world. We will need to evaluate new spool formats as we have a need for them.

THRML Merchant Software

(TMS)

Milestone: MVP (December 2021)

Overview

Summary

The THRML Merchant Software (TMS) is the background software that integrates directly into a Point-of-Sale Computers. Primary responsible for reading NFC chips and transmitting print spool data to the THRML Server.

Document Definitions

THRML Merchant Software (TMS)

The focus of this document. Background software that integrates directly into a Point-of-Sale Computers. Primary responsible for reading NFC chip and transmitting print spool data to the THRML Server.

THRML NFC Writer

The focus of this document. NFC chip writer application for writing unique IDs that can be used to link chips to a consumer's account.

THRML Server

THRML Server, as used in this document, is a general term for describing all internet-backed backend services that support THRML's consumer-facing products. Web API endpoints, databases, etc.

THRML Server—Consumer Data Processing Service

A backend service responsible for intake and processing consumer receipt data (the spooled print job).

THRML Server THRML Server—Command API

A backend service responsible for processing user commands related to writing to the database and storage of files. “Create New Card ID”, “Report Terminal Error”, etc.

THRML Server—Query API

A backend service responsible for processing request for data stored in the database or in file storage. “Get Terminal Error Log”, “Get List of Documents”, etc.

Architectural Details

Two event monitors control the THRML Merchant Software actions: an NFC Chip Scan Monitor; and a Windows Print Spooler Monitor.

When both monitors are silent, the application sits in a waiting state for an NFC Chip Scanned event.

On an NFC Chip scan event, the application notifies the Windows Print Spooler Monitor to capture the next spooled print job. Once the spooled print is capture it is then sent to the THRML Server for processing into a common file format.

Accept or Rejecting Requests for Print Capture

On NFC Chip Scan, the THRML Merchant Software starts validation to accept or reject the request for print capture (Highlighted in RED).

Validating THRML NFC Byte Code

Validation of the THRML NFC Byte Code is done as the first step of validating the NFC Chip was programed using the THRML NFC Writer. The unique byte code allows the TRHML Merchant Software to quickly and without the help of the THRML server reject non-THRML NFC chips.

The unique byte code written to every chip and shared with the THRML Merchant Software is:

{0x00, 0xDE, 0xED, 0xBE, 0xEF, 0x00}

The unique byte code is read to MIFARE Key Block 7.

Note that TMS and THRML NFC Reader share a common core for NFC settings. The NFC Byte Code and Block needs to be kept in sync with the THRML NFC Writer and shares common settings.

Validating Terminal ID & NFC Unique Key

On successfully validating the TRHML NFC Byte Code, TMS then read the NFC Key from MIFARE Key Block 5. The Terminal ID & NFC Key is sent to the THRM Server—Query API.

The THRML Server—Query API is responsible to validate that the Terminal ID & NFC Unique Key are valid and active.

If the Query API returns a successful code, indicating that both the Terminal ID & NFC Key are valid then the next print is scheduled for capture. On an error or failure code, the printer monitor remains idle.

Terminal ID

Each computer that TMS runs on is automatically assigned a unique ID called a Terminal ID. The Terminal ID is automatically registered with the THRML Server on first run.

All communication from the TMS to the THRML Server includes the Terminal ID allowing the THRML Server to map data to a specific origin. Likewise, the THRML Server can control if a Terminal is active for collecting documents or sending data.

The Terminal ID is stored locally in the system registry under: HKEY_CURRENT_USER\Software\THRML

Note that dealing the TerminalId regkey and restarting the TMS Service will force TMS to register as a new Terminal.

Operation Modes

The THRML Merchant software can operate as a standalone foreground application or as a background Windows Service.

Standalone Application

It's expected that the standalone application will be used on systems not dedicated as a Point-Of-Sale terminal. For example: running on a development system, testing out new hardware, or for one off items on a personal system.

When running as a standalone application there is no installation needed and the application doesn't modify any system setting.

Windows Service

Running as a Windows Services is the expected way that TMS will run on dedicated Pont-Of-Sale systems.

When installing the TMS as a Windows Services the TMS application is registered as a background Service with Windows. The TMS Service is set to automatically run in the background on system start and will automatically restart on error.

In addition to installing the TMS as a Windows Services the installation scripts attempt to set printers to the operation mode that best fit TMS functions. Specifically, the “Start printing after last page is spooled” and “Enable advanced print features” as enabled if they aren't already set.

Printer Settings

Start Printing After Last Page is Spooled

This setting guarantees that the print is spooled before attempting to send to the printer. Allowing the print job to completely spool before the printer attempts to print allows TMS to capture the print without having to race the printer for control of the spool.

Enable Advanced Print Features

When this setting is enabled print jobs are typically spooled in the EMF format. This setting allows spooled data send to the THRML Server Consumer Data Processing Service to be more consistent.

With this setting disabled, print jobs are spooled in a RAW format, which could be a verity of formats. Typical formats are XPS, PostScript, EMF, printer's native language, or 100+different formats.

When posable “Enable Advanced Print Features” should be enabled to allow minimize the file formats that the THRML Server Consumer Data Processing Service needing to support.

Note on some Windows version this setting maybe called “Always spool in RAW” and should be disabled on such systems.

Logging

The THRML Merchant Software logs to two end points when running as a service: Windows Event Logger; and the THRML Server—Command API.

When running as a standalone application all logging is ALSO displayed in the console UI.

Windows Event Logger

The THRML Merchant Software writes to the Windows Event Logger using the APPLICATION log name space, and the THRML event source. Log levels include Error, Information, and warning depending on severity.

THRML Server—Command API

The THRML Merchant Software calls two command API end points to produce an error and informational logs for select TMS actions. Note that only select errors and information is sent to the THRML Server.

API/V1/ReportNewTerminal

The ReportNewTerminal endpoint is called when the TMS creates a new Terminal ID on first run.

API/V1/TerminalLog

TerminalLog is sent an array of TerminalLog object as a generic logging interface. All Error and Warnings will be reported here along with select information messages.

public class TerminalLog {

public Guid Id {get; set;}

public Guid TerminalId {get; set;}

public string? LogCategory {get; set;}

public string? Message {get; set;}

}

Project Layout

The THRML Merchant Software application is based on a service architecture borrowing from Clean Architecture with business logic being self-contained within a single application project (.NET Core DLL). Application layer defined all in interfaces needed to perform domain specific tasks. The top-level UI layer (.Net Core Console or Windows Services) is responsible for Dependency Injection setup for each service. All other interfaces service implementation is responsible for their select tasks.

Technology Stack

Programing Languages

C# with .NET Core

Software Dependencies

winspool.dry Used by THRML.Merchant.Printing.Caputre to read and control the windows print spool.

PCSC.Iso7816 standard libraries NFC card access using the ISO standard formats.

System.Runtime.InteropServices Used for Marshal of system data

Hardware Requirements

1. NFC Card Reader/Writer capable of being recognized as an NFC device by Windows.

a. The Application has been tested and verified to work with ETEKJOY ACR122U NFC RFID 13.56 MHz Contactless Smart Card Reader/Writers.

2. NFC Chips in the standard 13.56 MHz MIFARE Classic 1K Rewritable

3. Printer that makes use of the Windows Spool

Software Requirements

1. Windows 10 with October 2010 updates or newer.

2. NFC Card Reader/Writer recognized by Windows Device Manager software and drivers working.

3. Printer Installed, configured, and recognized as a standard Windows printer.

Packaging

Run From Directory—Standalone Application

To run the THRML.Merchant.UI as a Standalone Application you only need to run the exe at which point you will get console UI

Install Scripts (For Service Install)

To install TMS as a Windows Services, use the install scrip (install.cmd)

Note that the utility scrip servicelnstall, and printerSettings are used as part of the install.

Utility Scripts

There are three PowerShell scripts that can be used by system administrators to configure and setup TMS.

Name Needed For

printSettings.ps1 This will update all printers to use “Start printing after last page is spooled” and “Enable advanced print features.”

serviceInstall.ps1 If not installed, this will install TMS as a Windows Service. If TMS is already installed as a Servers, this will stop the server and uninstall it.

serviceRestart.ps1 Helpful script of for restarting the TMS services.

Consumer Scenarios

The scenarios identified and documented below are top level success scenarios defined in the POC documentation and implemented in this milestone (MVP).

Scenario—Successful Checkout

Consumer Experience

1. The consumer begins the checkout process. ->

2. Consumer scans their unique NFC device. ->

3. The consumer completes their transaction by the delivery of payment. ->

4. The customer's receipt is accessible in their THRML account.

Events Produced:

1. NFC Chip Scanned. Created in step 2.

2. Receipt In Printer Spool. Created in step 3.

THRML Merchant Software Experience

The THRML Merchant Software waits in the background for two events: NFC Chip Scanned; and Receipt In Printer Spool.

On NFC Scanned Event

1. Read NFC from the device.

a. Validate NFC Chip contains the THRML NFC byte code in place

b. Read NFC Chip Key

2. Contact THRML Server to validate that:

a. NFC Chip Key is in the THRML ecosystem and active.

b. The Terminal is active and valid for use in the THRML ecosystem.

3. Flag receipt for capture.

On Receipt In Printer Spool Event with a Receipt flagged for capture

4. Pause the print job to prevent the receipt from printing.

5. Send spooled print job contents (and metadata about consumer account and merchant) to THML Server.

6. Delete print job from printer's spool.

Events Produced:

1. New Consumer Data Received. Created in step 5.

THRML Server—Consumer Data Processing Service

The THRML Server's Consumer Data Processing Service is responsible for the intake of new consumer data. On New Consumer Data Received:

1. Process data to standard file formats/sizes (PDF) needed by the THRML Consumer Application.

2. Send consumer data off to primary storage.

3. Notify other THRML Server components that new consumer data is available.

Supportability

Logging

The THRML Merchant Software logs to two end points when running as a service: Windows Event Logger; and the THRML Server—Command API.

When running as a standalone application all logging is ALSO displayed in the console UI. See ‘Logging’ under the ‘Architectural Details’ section for more information.

Tech Support Knowledge Base

Print being sent to printer before capture.

1) Verify that the printer properties are set as ‘Start Printing After Last Page is Spooled’. See ‘Printer Setup under the ‘Architectural Details’ section for more information.

2) Check windows event log for any error messages.

Unknown print spool format being sent to server or PDF not being created.

1) Verify that the printer properties are set as ‘Enable Advanced Print Features’. See ‘Printer Setup under the ‘Architectural Details’ section for more information.

2) On the server, check the spooler metadata and verify that the format is supported by the THRML Server—Consumer Data Processing Service.

Card Reader Not Recognized by the Windows Service

If the NFC card reader is not connected and working when the Windows Servers first starts, the TMS service may not recognize the new NFC reader be connected.

1) Restarting the TMS services or computer with the NFC Card reader connected.

Future Opportunities

Push Software Updates

The THRML Merchant Software is meant to be deployed to a Point-Of-Sale system and run for extended periods of time without needing updates or interaction directly. To extent it's functionality it would be nice to be able to auto deploy software updates from a remote endpoint.

Consolidate Server Actions

This MVP is calling into THRML Server—Consumer Data Processing Service directly. As the THRML Server architecture is finalized, it's likely that the TMS should only relay on the Command and Query APIs.

THRML NFC Writer

Milestone: MVP (December 2021)

Overview

Summary

The THRML NFC Writer is a Windows application that writes user input unique Keys (GUIDs) to an NFC chip. A THRML user can then scan the NFC Chip using the THRML Merchant Software to send documents to their THRML account.

The THRML NFC Writer is for exclusive use by THRML personnel to create NFC chips for THRML customers.

Document Definitions

THRML NFC Writer

The focus of this document. NFC chip writer application for writing unique IDs that can be used to link chips to a consumer's account.

THRML Merchant Software (TMS)

Background software that integrates directly into Point-of-Sale Computers. Primary responsible for reading NFC chip and transmitting print spool data to the THRML Server.

THRML Server

THRML Server, as used in this document, is a general term for describing all internet-backed backend services that support THRML's consumer-facing products. Web API endpoints, databases, etc.

Architectural Details

Unique Key

The THRML NFC Writer expects the user to input a GUID as the unique Key to be written to the card. Example Unique Key: 0e7ed623-c09d-4999-b6b1-75c3cef749da

The user input key is written to MIFARE Key Block 5. Note a GUID is the same size as a full MIFARE Key Block—16 bytes—and will overwrite/take the full MIFARE block.

Validating of the Unique Key

The THRML NFC Writer only validates that the Key is a valid GUID. The Application doesn't communicate or attempt to validate that the Key is right within the overall THRML ecosystem. It is expected that all Key validation and account linking is done by other THRML services.

Shared THRML NFC byte code

Along with the user input Key, the NFC chip is also signed with a unique byte code, used to validate the chip was programmed using a THRML NFC Writer. The unique byte code allows the TRHML Merchant Software to quickly and without the help of the THRML server reject non-THRML NFC chips.

The unique byte code written to every chip and shared with the THRML Merchant Software is:

{0x00, 0xDE, 0xED, 0xBE, 0xEF, Ox00}

The unique byte code is written to MIFARE Key Block 7.

Note that each MIFARE block size is 16 bytes. Any remaining bytes that are not written to a block are left unchanged.

Technology Stack

Programming Languages

Single Windows application using C# with .NET 4.X

User Interface

Windows Desktop application using Windows Presentation Foundation (WPF).

Software Dependencies

Name Needed For

PCSC.Iso7816 standard

libraries NFC card access using the ISO standard formats

MediatR Inner process messaging using the Mediator pattern

Windows Presentation Foundation (WPF) Windows UI framework.

MahApps.Metro UI toolkit for creating Metro/Modern UI-styled WPF apps.

Hardware Requirements

1. NFC Card Reader/Writer capable of being recognized as an NFC device by Windows.

a. The Application has been tested and verified to work with ETEKJOY ACR122U NFC RFID 13.56MHz Contactless Smart Card Reader/Writers.

2. NFC Chips in the standard 13.56MHz MIFARE Classic 1K Rewritable

Software Requirements

1. Windows 10 with October 2010 updates or newer.

2. NFC Card Reader/Writer recognized by Windows Device Manager software and drivers working.

Packaging

Setup Application

The THRML NFC Writer is packaged for install/uninstall using a Windows setup program (setup.exe). The setup directory registers the THRML NFC Writer application into the start menu and desktop shortcut. The Application is available for uninstalling with Window's Application uninstall system menu.

Consumer Scenarios

The scenarios identified and documented below are top-level success scenarios defined in the POC documentation and implemented in this milestone (MVP). Note that the THRML NFC Writer depends on other THRML services to create and manage the Unique Keys.

Scenario—Create A New THRML NFC Chip

Consumer Experience

1. The consumer creates a new THRML account. Or. The consumer requests a new NFC Chip from their account portal.

2. A new THRML NFC Chip, linked to their account, arrives in the mail.

Events Produced:

1. New NFC Chip Requested. Created in step 1.

THRML NFC Writer

The THRML NFC Writer is intended for use by a THRML Employ to create a new THRML NFC Chip containing a unique Id linked to the consumer's THRM account.

THRML Employee Experience

1. The employee receives the notification of a New NFC Chip Request and a unique Key that can link a Chip to a consumers' account.

2. The employee opens THRML NFC Writer.

3. Puts an NFC Chip onto the NFC Writer hardware.

4. Enter Unique Key provide in New NFC Chip Request

5. The new NFC Chip can be mailed out and used by the consumer on successful writing.

Events Produced:

1. New NFC Chip Produced. Created in step 4.

THRML Server

On New NFC Chip Requested Event:

1. Produce a new Unique chip Key and link it to the consumer's account

2. Relay request and Key to THRML Employ On New NFC Chip Produced Event:

1. Update database to set the unique ID as enabled.

Supportability

Logging

A trace log is produced and saved to %USERPROFILE%\Documents\THRMLNFCWriter\TraceLog.txt A real-time log is also produced using of System.Diagnostics.Trace

Diagnostic Tooling

None

Tech Support Knowledge Base

“No Card Writer Found” Message

This message will be displayed if there is no Card Writer recognized by Windows.

This message will not go away without restarting the program. If you plug in a USB Card Writer after the Application is open, you will need to restart the Application before the Card Writer is recognized.

“Bad Key” or “Check Key and try again” Message.

The Application failed to convert the input key to a valid GUID. Verify that the Key is in the correct format. Example key will look like: 0e7ed623-c09d-4999-b6b1-75c3cef749da

THRML Merchant Software MVP Meeting

December 15, 2021

Document Scope

This document is quick reference for the THRML TMS MVP meeting on December 15, 2021. See supporting documentation for more information.

Component Definitions

Definition of THRML Component/Products as they relate to this document.

THRML NFC Writer

NFC device writer application for writing unique IDs to NFC devices and linking the IDs to a consumer's account.

THRML Merchant Software (TMS)

Background software that integrates directly into a Point-of-Sale Computers. Primary responsible for reading NFC devices and transmitting print spool data to the THRML Server.

THRML Server

THRML Server, as used in this document, is a general term for describing all internet-backed backend services that support THRML's consumer-facing products. Web API endpoints, databases, etc.

THRML Server—Consumer Data Processing Service

A backend service responsible for intake and processing consumer receipt data (the spooled print job).

THRML Server—File Storage & Content Delivery Network (CDN)

Handles file storage for archive of original print spooled files, files need THRML Consumer Application (pdf, etc.), and distributing the receipt in common file format (PDF) to other services.

THRML Server—Database

Storage for relational data. Card IDs, Terminal Data, user account information. There may be more than one database to serve specific services.

THRML Server THRML Server—Command API

A backend service responsible for processing user commands related to writing to the database and storage of files. “Create New Card ID”, “Report Terminal Error”, etc.

THRML Server—Query API

A backend service responsible for processing request for data stored in the database or in file storage. “Get Terminal Error Log”, “Get List of Documents”, etc.

THRML Consumer Application

The consumer and admin-facing endpoint allows access to their data—Web portal. Makes use of the THRML Server API end points.

Overview Status

THRML Merchant Software and its support components (THRML NFC Writer and THRML Server Consumer Data Processing Servers) are at MVP level. Small updates will be needed once Server components are finalized. See supporting document for more details.

THML Server Components (API, Web, Database, and CDN) are in Placeholder level.

Plan For TRHML Server Overview

Move to distributed service architecture where self-contained services can operate and be maintained independently.

Updates From MVP components:

1) Move Consumer Data Processing Service API into the API Command service. All external data writes from 1 end point.

2) Include a Message Bus provider (RabbitMQ or Azure Event)

Hosting

Cost

Azure Database: $10/month (production)

Azure Compute Resources: $15/month (starting)—$75/month for mid-production. AWS S3 File Storage: $0.023 per GB/month

Firebase Auth: Free

Representative software code for implementation of a preferred embodiment of the present invention is attached hereto as Appendix A-1.

What is claimed is:

1. A system for paperless documenting of proof of purchase comprising:
a Point-of-Sale system for registering products for sale;
a personalized NFC device in communication with the Point-of-Sale system for generating a unique code;
a communication lane associated with the unique code created between the now open account and the transaction occurring at the Point-of-Sale system configured to send the unique code via a computer network to a server;
a first subsystem for placing a hold on the top of the merchant's printer spool at the Point of Sale, and holding it open until the transaction is complete;
a second subsystem in communication with the first subsystem for sending transaction receipt information to the merchant print spool; and
a third subsystem in communication with the second subsystem for creating and storing an exact archetype of the receipt information, and sending it via the open communication line to the server, and placing it in the consumer's account that corresponds with their unique code associated with their NFC identification.
